(19) United States
(12) Patent Application Publication
(10) Pub. No.: US 2021/0398162 A1
(43) Pub. Date: Dec. 23, 2021

(54) SYSTEM AND METHOD FOR REWARD DISTRIBUTION BASED ON PURCHASE PATTERN RECOGNITION

(71) Applicant: VISA INTERNATIONAL SERVICE ASSOCIATION, San Francisco, CA (US)

(72) Inventors: Prithwiraj Mitra, Foster City, CA (US); Nitin Singhal, San Jose, CA (US); Sukalyan Chakraborty, Foster City, CA (US); Urjit Anand Khadilkar, San Mateo, CA (US); Nikhil Ghate, Sunnyvale, CA (US); Mahesh Joshi, Belmont, CA (US)

(21) Appl. No.: 17/281,793

(22) PCT Filed: Sep. 27, 2019
(86) PCT No.: PCT/US2019/053494

§ 371 Date: Mar. 31, 2021

Related U.S. Application Data
(60) Provisional application No. 62/739,414, filed on Oct. 1, 2018.

(51) Int. Cl. G06Q 30/02; G06Q 40/02

(52) U.S. Cl. CPC G06Q 30/0226; G06Q 40/02; G06Q 30/0201

(57) ABSTRACT

A system and computer-implemented method distributes rewards and loyalty points in a payment network based on purchase patterns. The system and method may receive purchase data corresponding to a plurality of purchases where the purchase data includes a merchant, a purchase location, and a purchase time. The system and method may then determine a shopping pattern based on the purchase data. The shopping pattern may indicate a probability that a first purchase transaction beginning at a first store will proceed to a second purchase transaction at a second store. The system and method may also receive further purchase data corresponding to a user computer system and compare it to the shopping pattern. The system and method may then send, to the user computer system, one or more of rewards and loyalty points corresponding to the second store when the further purchase data includes the first store.

### BACKGROUND

Credit and debit card-based purchases within shopping malls are unique in that multiple purchases are often made between multiple merchants within a short period of time and within close proximity to each other. For example, a cardholder might purchase a first item at a department store, then walk to another store to purchase a second item. Purchase patterns for typical shoppers emerge over time and could provide an opportunity for loyalty and rewards incentives for shoppers. However, in order to provide such a benefit, purchases and store locations must be tracked accurately.

### SUMMARY

The following presents a simplified summary of the present disclosure in order to provide a basic understanding of some aspects of the disclosure. This summary is not an extensive overview. It is not intended to identify key or critical elements of the disclosure or to delineate its scope. The following summary merely presents some concepts in a simplified form as a prelude to the more detailed description provided below.

In some embodiments, a computer-implemented method or a system including a processor and a memory may include instructions for distributing rewards and loyalty points in a payment network based on purchase patterns. The system and method may receive purchase data corresponding to a plurality of purchases where the purchase data includes a merchant, a purchase location, and a purchase time. The system and method may then determine a shopping pattern based on the purchase data. The shopping pattern may indicate a probability that a first purchase transaction beginning at a first store will proceed to a second purchase transaction at a second store. The system and method may also receive further purchase data corresponding to a user computer system and compare it to the shopping pattern. The system and method may then send, to the user computer system, one or more of rewards and loyalty points corresponding to the second store when the further purchase data includes the first store.

### BRIEF DESCRIPTION OF THE FIGURES

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 shows an illustration of an exemplary purchase tracking system;

FIG. 2A shows a first view of an exemplary payment device for use with the system of FIG. 1;

FIG. 2B shows a second view of an exemplary payment device for use with the system of FIG. 1;

FIG. 3 is a flowchart of a method for tracking purchases within a shopping mall; and

FIG. 4 shows an exemplary computing device that may be physically configured to execute the methods and include the various components described herein.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### DETAILED DESCRIPTION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, components, or devices. Accordingly, the present invention may take the form of an entirely hardware embodiment, an entirely software embodiment, or an embodiment combining software and hardware aspects. The following detailed description is, therefore, not to be taken in a limiting sense.

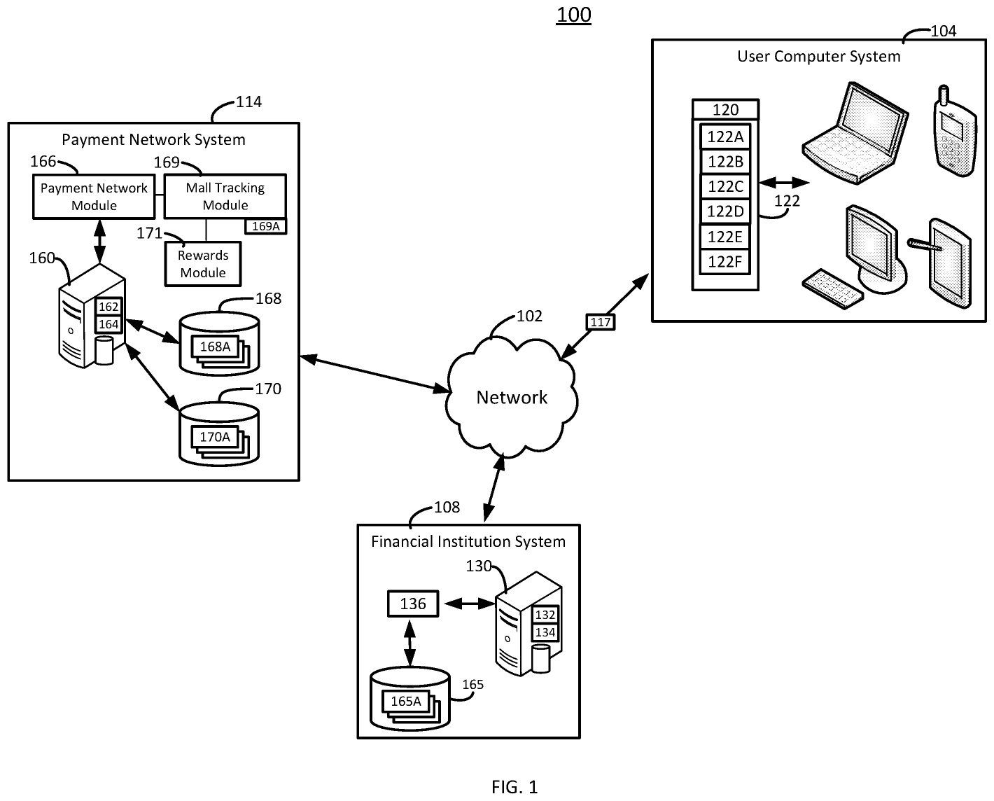

FIG. 1 generally illustrates one embodiment of a system 100 for tracking a plurality of users' purchases within a shopping mall in order to determine and, thus, predict shopping patterns for future purchases. The system 100 may include a computer network 102 that links one or more systems and computer components. In some embodiments, the system 100 also includes a user computer system 104, a financial institution system 108, and a payment network system 114.

The network 102 may be described variously as a communication link, computer network, internet connection, etc. The system 100 may include various software or computer-executable instructions or components stored on tangible computer memories and specialized hardware components or modules that employ the software and instructions to track user purchases in order to predict future purchases.

The various modules may be implemented as computer-readable storage memories containing computer-readable instructions (e.g., software) for execution by one or more processors of the system 100 within a specialized or unique computing device. The modules may perform the various tasks, methods, blocks, sub-modules, etc., as described herein. The system 100 may also include both hardware and software applications, as well as various data communications channels for communicating data between the various specialized and unique hardware and software components.

The network 102 may comprise the interconnection and interoperation of hardware, data, and other entities of the system 100. The network 102 is a digital telecommunications network which allows nodes of the system 100 (e.g., the user computer system 104, the financial institution system 108, and the payment network system 114) to share resources. In computer networks, computing devices exchange data with each other using connections, e.g., data links, between nodes. Hardware networks, for example, may include clients, servers, and intermediary nodes in a graph topology. In a similar fashion, data networks may include data nodes in a graph topology where each node includes related or linked information, software methods, and other data. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications or data network. A computer, other device, set of related data, program, or combination thereof that facilitates, processes information and requests, and/or furthers the passage of information from a source user to a destination user is commonly referred to as a “node.” Networks generally facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

A user computer system 104 may include a processor 120 and memory 122. The user computer system 104 may include a server, a mobile computing device, a smartphone, a tablet computer, a Wi-Fi-enabled device or other personal computing device capable of wireless or wired communication, a thin client, or other known type of computing device. The memory 122 may include various modules including instructions that, when executed by the processor 120 control the functions of the user computer system generally and integrate the user computer system 104 into the system 100 in particular. For example, some modules may include a user operating system 122A, a user browser module 1228, a user communication module 122C, a user electronic wallet module 122D, a user location module 122E, and a user purchase module 122F. In some embodiments, one or more of the user electronic wallet module 122D and/or the user purchase module 122 and their functions described herein may be incorporated as one or more modules of the user computer system 104. In other embodiments, the user electronic wallet module 122D and its functions described herein may be incorporated as one or more sub-modules of the financial institution system 108 and/or the payment network system 114.

In some embodiments, a module of the user computer system 104 may pass user purchase data 117 to other components of the system 100 to facilitate tracking current purchases to determine predictions about future purchases. For example, one or more of the user operating system 122A, user browser module 1228, user communication module 122C, user electronic wallet module 122D, user location module 122E, and user purchase module 122F may pass purchase data 117 data to a financial institution system 108 and/or to the payment network system 114 to facilitate tracking and predicting determinations. In some embodiments, the user location module 122E may append user location data to the purchase data 117 and the user purchase module 122F may append timestamp data onto the purchase data 117 before one or more modules of the user computer system forwards the purchase data 117 to other components of the system 100. Purchase data 117 passed from the user computer system 104 to other components of the system may include a user name, a user purchase amount, financial institution system account data 165A, payment network system account data 168A, merchant data, purchase location data, purchase timestamp data, and other data. Other data may include an email address, a telephone number, a physical address, a MAC address, an IP address, an account identification, or other data that may allow the system 100 to track current purchases in order to determine purchase patterns to predict future purchases. The user computer system 104 may be indicated within and correspond to the account data 165A of the financial institution system 108 and/or the account data 168A of the payment network system 114.

The financial institution system 108 may include a computing device such as a financial institution server 130 including a processor 132 and memory 134 including components to receive purchase data 117 from the user computer system 104 to facilitate tracking user purchases and predicting future purchases. The purchase data 117 from the user computer system 104, as described above, may include data to track current purchases from the user computer system 104 that may be accumulated across a plurality of user computing devices in order to predict future purchases. For example, merchant data, purchase location data, and purchase timestamp data may be accumulated and analyzed to develop shopping patterns across the plurality of merchants. In some embodiments, the financial institution server 130 may include one or more modules 136 stored on the memory 134 including instructions that, when executed by the processor 132 receive purchase data 117 from the user computer system 104 and accumulate the purchase data 117 within a financial institution system account repository 165 as a purchase history for each user in financial institution system account data 165A.

The payment network system 112 may include a computing device such as a payment network server 160 including a processor 162 and memory 164 including a payment network module 166. The payment network module 166 may include instructions to facilitate each purchase made by a user computer system 104 including payment information for each user computer system (e.g., a personal account number or PAN) as well as instructions to secure and/or tokenize payment network account data 168A for each user computer system 104 for a purchase transaction. The payment network module 166 may also include instructions to accumulate the purchase data 117 for each user computer system 104 corresponding to the payment network account data 168A and stored within a payment network data repository 168. The payment network system 112 may also include a merchant data repository 170 including merchant data 170A. Merchant data 170A may include merchant identifying information such as a merchant name, a merchant address, a merchant account number, merchant transaction records, etc.

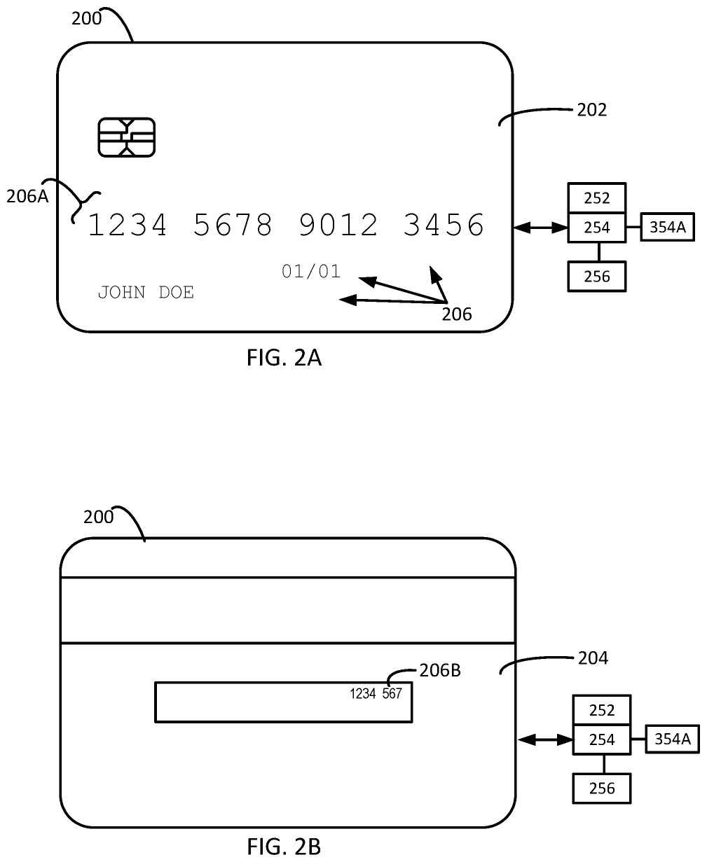

The payment network system 112 may also include a mall tracking module 169. The mall tracking module 169 may include instructions to filter merchant data 170A known to be in a mall from third party sources providing mall information. Third party sources may include websites, industry data, news data, phone directories, and other sources that may list current merchants within a mall. The instructions to filter the merchant data 170A may also include instructions to filter out payment network data 168A with a plurality of purchase data 117 indicating multiple transactions within a single mall within a threshold time period (e.g., one day). The mall tracking module 169 may also include instructions to analyze the accumulated purchase data 117 from the payment network data repository 168 to build shopping patterns 169A from the accumulated purchase data. The shopping patterns 169A may include data indicating that a user computer system 104 generally and a payment device 200 (FIG. 2) in particular may be used within a calculated probability at a particular merchant based on past purchases. For example, the patterns may provide information like “after a purchase at Store W within the mall, the pattern predicts within a probability of X % that the same user computer system 104 or payment device 200 may be used to make a purchase at Store Y within a time period Z.” In this way, the shopping patterns 169A may be described as a “path of purchases” throughout the mall having a mix of merchants indicated by the merchant data 170A or not indicated by the data 170A, using the elapsed time indicated by the average time between the timestamps included with the purchase data 117 as well as the location for each consecutive purchase as indicated by the location module 122E during each purchase. This “path of purchases” may also be used to determine if unknown merchants are within a mall by analyzing the elapsed time between transactions, the probability of consecutive transactions at distances more than a threshold, and mall data from third parties.

The payment network system 112 may also include a rewards module 171. The rewards module 171 may include instructions to use the shopping patterns 169 to allocate rewards to particular accounts indicated by the payment network data 168A that, within a threshold probability, will follow a particular shopping pattern 169. For example, if the shopping pattern 169 indicates a “path of purchases” of Store A to Store B to Store C and the purchase data 117 for a set of payment network data 168A indicates current purchases showing a path of Store A to Store B, then the rewards module 171 may cause a processor to execute an instruction to provide a reward 171A to the user computer device 104 corresponding to the purchases for Store C. A reward 171A may include coupons, loyalty points, and other discounts for purchases at Store C or any other merchant.

In some embodiments, the mall tracking module 169 may include instructions to supplement missing merchant data 170A. For example, if a shopping pattern 169A indicates a path of Store A to Store B to Store C, if the repository 170 does not include address data for Store B, but does include address data for Store A and Store C, then the module 169 may cause a processor to execute an instruction to interpolate the addresses of Store A and Store C to determine the missing address for Store B. Such determination of store addresses may be more accurate when distance data between transactions from Store A and Store C are within a threshold, thus indicating that Store B is a neighbor to Store A and Store C.

With brief reference to FIGS. 2A and 2B, an exemplary payment device 200 associated with the purchase data 117 may take on a variety of shapes and forms. In some embodiments, the payment device 200 is a traditional card such as a debit card or credit card. In other embodiments, the payment device 200 may be a fob on a key chain, an NFC wearable, or other device. In other embodiments, the payment device 200 may be an electronic wallet where one account from a plurality of accounts previously stored in the wallet is selected and communicated to the system 100 to execute the transaction. As long as the payment device 200 is able to communicate securely with the system 100 and its components, the form of the payment device 200 may not be especially critical and may be a design choice. For example, many legacy payment devices may have to be read by a magnetic stripe reader and thus, the payment device 200 may have to be sized to fit through a magnetic card reader. In other examples, the payment device 200 may communicate through near field communication and the form of the payment device 200 may be virtually any form. Of course, other forms may be possible based on the use of the card, the type of reader being used, etc.

Physically, the payment device 200 may be a card and the card may have a plurality of layers to contain the various elements that make up the payment device 200. In one embodiment, the payment device 200 may have a substantially flat front surface 202 and a substantially flat back surface 204 opposite the front surface 202. Logically, in some embodiments, the surfaces 202, 204 may have some embossments 206 or other forms of legible writing including a personal account number (PAN) 206A and the card verification number (CVN) 206B. In some embodiments, the payment device 200 may include data corresponding to the primary account holder, such as payment network account data 164A for the account holder. A memory 254 generally and a module 254A in particular may be encrypted such that all data related to payment is secure from unwanted third parties. A communication interface 256 may include instructions to facilitate sending payment data such as a payment payload, a payment token, or other data to identify payment information to one or more components of the system 100 via the network 102.

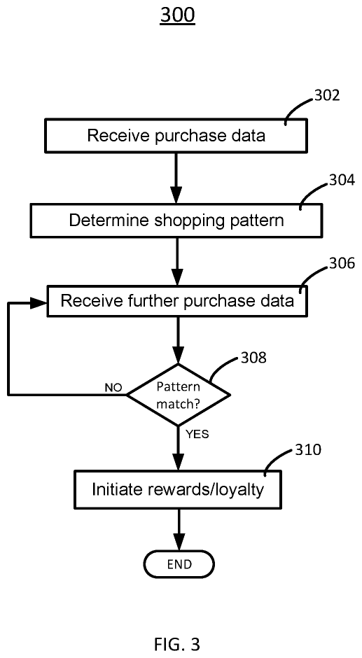

FIG. 3 is a flowchart of a method 300 for tracking mall-based purchase data 117 and predicting future purchase behavior between individuals and merchants. Each step of the method 300 is one or more computer-executable instructions performed on a server or other computing device which may be physically configured to execute the different aspects of the method. Each step may include execution of any of the instructions as described in relation to the system 100. While the below blocks are presented as an ordered set, the various steps described may be executed in any particular order to complete the mall purchase tracking and prediction methods described herein.

At block 302, the method 300 may cause a processor of the system 100 to receive purchase data 117 corresponding to a plurality of purchases. In some embodiments, the purchase data includes a merchant name, a purchase location, and a purchase time for each of the plurality of purchases. The method 100 may also cause one or more modules of the user computer system 104 to append further data to the purchase data 117. For example, the method 100 may cause a user location module 122E and a user purchase module 122F to append a location and a time for the transaction corresponding to the purchase data 117. One or more of the financial institution system 108 and the payment network system 114 may receive the purchase data 117.

At block 304, the method 100 may cause a processor of the system 100 to determine a shopping pattern 169A based on the purchase data 117 corresponding to a plurality of purchases. As described above in relation to the system 100, the method 300 may cause a processor of the system 100 to analyze the accumulated purchase data 117 from the payment network data repository 168 and build shopping patterns 169A from the accumulated purchase data. Each shopping pattern 169 may indicate a probability that purchase data 117 corresponding to a first store will also correspond to further purchase data 117 associated with a second store.

At block 306, the method 100 may cause a processor to receive further purchase data 117 corresponding to a user computer system 104 and, at block 308, cause a processor of the system 100 to compare the further purchase data 117 to one or more of the accumulated purchase data 117 of the financial institution account data 165A and/or the payment network system account data 168A. If, at block 308, the further purchase data 117 matches a shopping pattern 169A, then the method 300 may cause a processor of the system 100 to send rewards and/or loyalty points to the user computer system 104 that initiated the further purchase data 117. If, at block 608, the further purchase data 117 does not match a shopping pattern 169A, then the method 300 may cause a processor of the system 100 to return to block 306 and wait for more purchase data 117.

Thus, the present disclosure provides a technical solution to the technical problem of determining shopping patterns within a mall and initiating rewards and/or loyalty points for users who fit the patterns to encourage further purchases that are indicated in past shopping habits of other users. The disclosed system 100 and method 300 improves past systems and methods to send loyalty and/or rewards for a first store based only on the user's past purchases with that store. By determining a probability of follow-on purchases at particular stores within a mall, the system 100 and method 300 may increase the use of the rewards/loyalty points based on a determined likelihood that the follow-on transaction will occur.

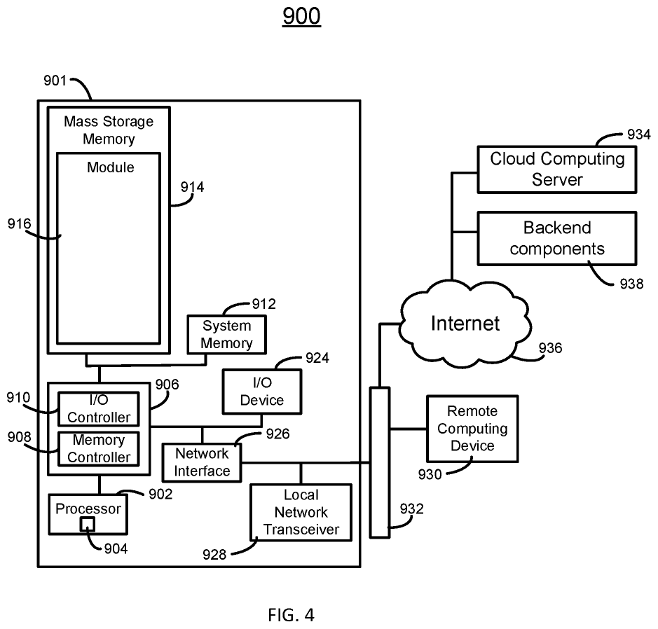

FIG. 4 is a high-level block diagram of an example computing environment 900 for the system 100 and methods (e.g., method 300) as described herein. The computing device 900 may include a server (e.g., the user computer system 104, the financial institution server 130, the payment network server 160, etc.), a mobile computing device (e.g., user computer system 104), a tablet computer, a Wi-Fi-enabled device or other personal computing device capable of wireless or wired communication), a thin client, or other known type of computing device.

Logically, the various servers may be designed and built to specifically execute certain tasks. For example, the payment network server 160 may receive a large amount of data in a short period of time meaning the payment network server may contain a special, high speed input output circuit to handle the large amount of data. Similarly, the financial institution server 130 may execute processor-intensive modules and thus the server 130 may have increased processing power that is specially adapted to quickly execute certain algorithms.

As will be recognized by one skilled in the art, in light of the disclosure and teachings herein, other types of computing devices can be used that have different architectures. Processor systems similar or identical to the example systems and methods described herein may be used to implement and execute the example systems and methods described herein. Although the example system 100 is described below as including a plurality of peripherals, interfaces, chips, memories, etc., one or more of those elements may be omitted from other example processor systems used to implement and execute the example systems and methods. Also, other components may be added.

As shown in FIG. 4, the computing device 901 includes a processor 902 that is coupled to an interconnection bus. The processor 902 includes a register set or register space 904, which is depicted in FIG. 4 as being entirely on-chip, but which could alternatively be located entirely or partially off-chip and directly coupled to the processor 902 via dedicated electrical connections and/or via the interconnection bus. The processor 902 may be any suitable processor, processing unit or microprocessor. Although not shown in FIG. 4, the computing device 901 may be a multi-processor device and, thus, may include one or more additional processors that are identical or similar to the processor 902 and that are communicatively coupled to the interconnection bus.

The processor 902 of FIG. 4 is coupled to a chipset 906, which includes a memory controller 908 and a peripheral input/output (I/O) controller 910. As is well known, a chipset typically provides I/O and memory management functions as well as a plurality of general purpose and/or special purpose registers, timers, etc. that are accessible or used by one or more processors coupled to the chipset 906. The memory controller 908 performs functions that enable the processor 902 (or processors if there are multiple processors) to access a system memory 912 and a mass storage memory 914, that may include either or both of an in-memory cache (e.g., a cache within the memory 912) or an on-disk cache (e.g., a cache within the mass storage memory 914).

The system memory 912 may include any desired type of volatile and/or non-volatile memory such as, for example, static random access memory (SRAM), dynamic random access memory (DRAM), flash memory, read-only memory (ROM), etc. The mass storage memory 914 may include any desired type of mass storage device. For example, the computing device 901 may be used to implement a module 916 (e.g., the various modules as herein described). The mass storage memory 914 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 901, the systems and methods described herein. Thus, a module, block, function, operation, procedure, routine, step, and method can be implemented in hardware, firmware, and/or software. In one embodiment, program modules and routines are stored in mass storage memory 914, loaded into system memory 912, and executed by a processor 902 or can be provided from computer program products that are stored in tangible computer-readable storage mediums (e.g. RAM, hard disk, optical/magnetic media, etc.).

The peripheral I/O controller 910 performs functions that enable the processor 902 to communicate with a peripheral input/output (I/O) device 924, a network interface 926, a local network transceiver 928, (via the network interface 926) via a peripheral I/O bus. The I/O device 924 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 924 may be used with the module 916, etc., to receive data from the transceiver 928, send the data to the components of the system 100, and perform any operations related to the methods as described herein. The local network transceiver 928 may include support for a Wi-Fi network, Bluetooth, Infrared, cellular, or other wireless data transmission protocols. In other embodiments, one element may simultaneously support each of the various wireless protocols employed by the computing device 901. For example, a software-defined radio may be able to support multiple protocols via downloadable instructions. In operation, the computing device 901 may be able to periodically poll for visible wireless network transmitters (both cellular and local network) on a periodic basis. Such polling may be possible even while normal wireless traffic is being supported on the computing device 901. The network interface 926 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 908 and the I/O controller 910 are depicted in FIG. 4 as separate functional blocks within the chipset 906, the functions performed by these blocks may be integrated within a single integrated circuit or may be implemented using two or more separate integrated circuits. The computing environment 900 may also implement the module 916 on a remote computing device 930. The remote computing device 930 may communicate with the computing device 901 over an Ethernet link 932. In some embodiments, the module 916 may be retrieved by the computing device 901 from a cloud computing server 934 via the Internet 936. When using the cloud computing server 934, the retrieved module 916 may be programmatically linked with the computing device 901. The module 916 may be a collection of various software platforms including artificial intelligence software and document creation software or may also be a Java® applet executing within a Java® Virtual Machine (JVM) environment resident in the computing device 901 or the remote computing device 930. The module 916 may also be a “plug-in” adapted to execute in a web-browser located on the computing devices 901 and 930. In some embodiments, the module 916 may communicate with back end components 938 via the Internet 936.

The system 900 may include but is not limited to any combination of a LAN, a MAN, a WAN, a mobile, a wired or wireless network, a private network, or a virtual private network. Moreover, while only one remote computing device 930 is illustrated in FIG. 4 to simplify and clarify the description, it is understood that any number of client computers are supported and can be in communication within the system 900.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A computer-implemented method of distributing rewards and loyalty points in a payment network based on purchase patterns, the method comprising:
receiving purchase data corresponding to a plurality of purchases, the purchase data including a merchant, a purchase location, and a purchase time;
determining a shopping pattern based on the purchase data corresponding to a plurality of purchases, wherein the shopping pattern indicates a probability that a first purchase transaction beginning at a first store will proceed to a second purchase transaction at a second store, the probability being above a threshold;
receiving further purchase data from a user computer system;
comparing the further purchase data to the shopping pattern; and
sending, to the user computer system, one or more of rewards and loyalty points corresponding to the second store when the further purchase data includes the first store.

2. The method of claim 1, further comprising appending a purchase location and a purchase time to the purchase data in response to receiving the purchase data corresponding to the plurality of purchases.

3. The method of claim 2, wherein the purchase data includes one or more of a user name, a user purchase amount, financial institution system account data, payment network system account data, merchant data, purchase location data, and purchase timestamp data.

4. The method of claim 3, wherein determining the shopping pattern based on the purchase data corresponding to the plurality of purchases includes analyzing the purchase data corresponding to the plurality of purchases.

5. The method of claim 4, further comprising determining a plurality of transactions within a single mall, the plurality of transactions corresponding to a user name based on the purchase data.

6. The method of claim 5, wherein comparing the further purchase data to the shopping pattern includes comparing the further purchase data to the purchase data corresponding to the plurality of purchases.

7. The method of claim 6, further comprising determining an address for an unknown merchant of the plurality of transactions within the single mall based on an elapsed time between two or more of the plurality of transactions being below a threshold.

8. A system comprising:
a processor and a memory in communication with the processor, the memory storing instructions that, when executed by the processor, cause the processor to:
receive purchase data corresponding to a plurality of purchases, the purchase data including a merchant, a purchase location, and a purchase time;
determine a shopping pattern based on the purchase data corresponding to a plurality of purchases, wherein the shopping pattern indicates a probability that a first purchase transaction beginning at a first store will proceed to a second purchase transaction at a second store, the probability being above a threshold;
receive further purchase data from a user computer system;
compare the further purchase data to the shopping pattern; and
send, to the user computer system, one or more of rewards and loyalty points corresponding to the second store when the further purchase data includes the first store.

9. The system of claim 8, further comprising instructions to append one or more of a purchase location and a purchase time to the purchase data in response to the instructions to receive the purchase data corresponding to the plurality of purchases.

10. The system of claim 9, wherein the instructions to determine the shopping pattern based on the purchase data corresponding to the plurality of purchases includes instructions to analyze the purchase data corresponding to the plurality of purchases.

11. The system of claim 10, wherein the instructions to compare the further purchase data to the shopping pattern includes instructions to compare the further purchase data to the purchase data corresponding to the plurality of purchases.

12. The system of claim 11, further comprising instructions to determine a plurality of transactions within a single mall, the plurality of transactions corresponding to a user name based on the purchase data.

13. The system of claim 12, wherein instructions to compare the further purchase data to the shopping pattern includes instructions to compare the further purchase data to the purchase data corresponding to the plurality of purchases.

14. The system of claim 13, further comprising instructions to determine an address for an unknown merchant of the plurality of transactions within the single mall based on an elapsed time between two or more of the plurality of transactions being below a threshold.

15. A non-transitory tangible computer-readable medium having computer-executable instructions stored thereon, the computer-executable instructions comprising:
receiving purchase data corresponding to a plurality of purchases, the purchase data including a merchant, a purchase location, and a purchase time;
determining a shopping pattern based on the purchase data corresponding to a plurality of purchases, wherein the shopping pattern indicates a probability that a first purchase transaction beginning at a first store will proceed to a second purchase transaction at a second store, the probability being above a threshold;
receiving further purchase data from a user computer system;
comparing the further purchase data to the shopping pattern; and
sending, to the user computer system, one or more of rewards and loyalty points corresponding to the second store when the further purchase data includes the first store.

16. The non-transitory tangible computer-readable medium of claim 15, further comprising computer-executable instructions for appending one or more of a purchase location and a purchase time to the purchase data in response to receiving the purchase data corresponding to the plurality of purchases.

17. The non-transitory tangible computer-readable medium of claim 16, wherein the instructions for determining the shopping pattern based on the purchase data corresponding to the plurality of purchases includes instructions for analyzing the purchase data corresponding to the plurality of purchases.

18. The non-transitory tangible computer-readable medium of claim 17, wherein the instructions for comparing the further purchase data to the shopping pattern includes instructions for comparing the further purchase data to the purchase data corresponding to the plurality of purchases.

19. The non-transitory tangible computer-readable medium of claim 11, further comprising instructions to:
determine a plurality of transactions within a single mall, the plurality of transactions corresponding to a user name based on the purchase data; and
determine an address for an unknown merchant of the plurality of transactions within the single mall based on an elapsed time between two or more of the plurality of transactions being below a threshold.

20. The non-transitory tangible computer-readable medium of claim 19, wherein instructions to compare the further purchase data to the shopping pattern includes instructions to compare the further purchase data to the purchase data corresponding to the plurality of purchases.
